(19) United States
(12) Patent Application Publication
(10) Pub. No.: US 2012/0139869 A1
(43) Pub. Date: Jun. 7, 2012

(54) REATTACHABLE TOUCH INPUT DEVICE

(76) Inventor: CHIEN-HSIEN YU, HSINCHU CITY (TW)

(21) Appl. No.: 13/308,741

(22) Filed: Dec. 1, 2011

(30) Foreign Application Priority Data
Dec. 3, 2010 (TW) 099142126

(51) Int. Cl. G06F 3/045; G06F 3/041

(52) U.S. Cl. 345/174; 345/173

(57) ABSTRACT

A reattachable touch input device is for use with an electronic device. The reattachable touch input device includes a touch sensing layer and a reattachable attachment member. The touch sensing layer is operable to generate a touch position signal in response to at least one touch action detected thereby. The reattachable attachment member is disposed under the touch sensing layer and is configured for releasable attachment of the reattachable touch input device to a surface.

### CROSS-REFERENCE TO RELATED APPLICATION

This application claims priority of Taiwanese application No. 099142126, filed on Dec. 3, 2010.

### BACKGROUND OF THE INVENTION

1. Field of the Invention

This invention relates to a touch input device, more particularly to a reattachable touch input device for use with an electronic device.

2. Description of the Related Art

Touch input technology are increasingly used in consumer electronic devices whereas the majority of electronic devices employ a mouse or a keyboard as an input interface, for example, less than 30% of mobile phones and less than 10% of personal computers and notebook computers employ touch input devices as an input interface. However, manufacturers need to redesign various electronic devices to provide touch input functionality for the electronic devices, which results in higher manufacturing costs. Therefore, it is desirable to provide a touch input device that can be used with various electronic devices without having to redesign the electronic devices.

### SUMMARY OF THE INVENTION

Therefore, the object of the present invention is to provide a reattachable touch input device that can be used with various electronic devices.

According to this invention, the reattachable touch input device comprises a touch sensing layer and a reattachable attachment member. The touch sensing layer is operable to generate a touch position signal in response to at least one touch action detected thereby. The reattachable attachment member is disposed under the touch sensing layer and is configured for releasable attachment of the reattachable touch input device to a surface.

### BRIEF DESCRIPTION OF THE DRAWINGS

Other features and advantages of the pre sent invention will become apparent in the following detailed description of the preferred embodiment of the invention, with reference to the accompanying drawings, in which:

FIG. 1 is a schematic block diagram of a preferred embodiment of a reattachable touch input device according to the present invention, illustrating a processing module of the preferred embodiment including a wired transmission module;

FIG. 2 is a schematic block diagram of a modification of the preferred embodiment, illustrating the processing module including a wireless transmission module;

FIG. 3 is a schematic block diagram of another modification of the preferred embodiment, illustrating a touch sensing device of the preferred embodiment being wirelessly coupled to the control module;

FIG. 4 is a schematic block diagram of still another modification of the preferred embodiment, illustrating a controller and a microprocessor of the processing module being connected wirelessly;

FIG. 5 illustrates the preferred embodiment attached to a display screen of an electronic device;

FIG. 6 is a schematic view of the preferred embodiment used with the electronic device shown in FIG. 5;

FIG. 7 illustrates the preferred embodiment attached to a surface on which a projected image from a projector coupled to another electronic device is displayed;

FIG. 8 is a schematic view of the preferred embodiment used with the projector and the electronic device shown in FIG. 7;

FIG. 9 illustrates the preferred embodiment disposed under a piece of paper; and

FIG. 10 is a schematic view of the preferred embodiment used with an electronic device and a storage device shown in FIG. 9.

### DETAILED DESCRIPTION OF THE PREFERRED EMBODIMENT

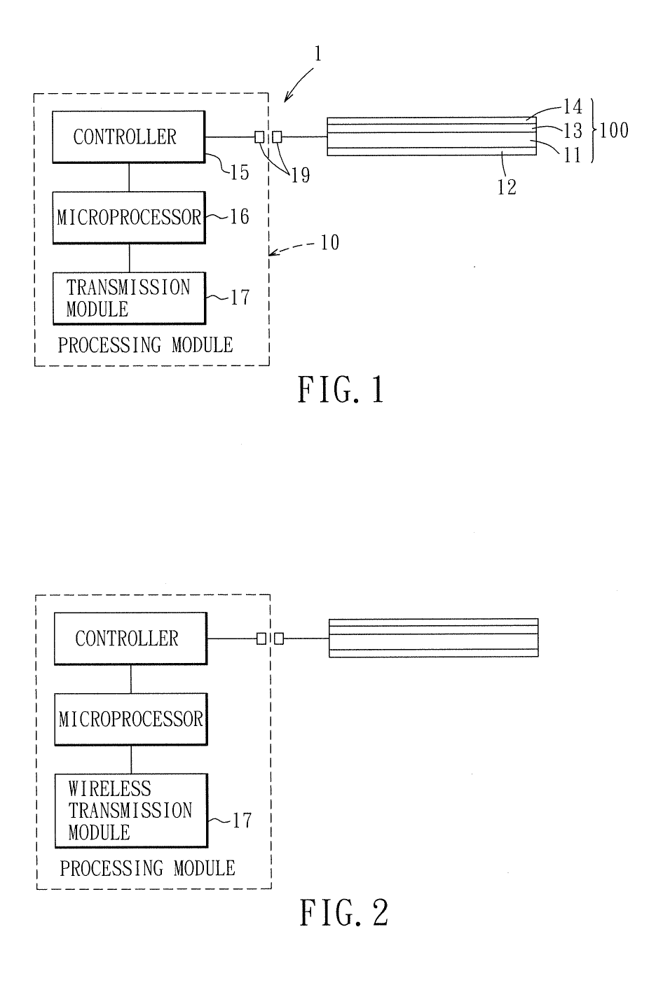

Referring to FIG. 1, a preferred embodiment of the reattachable touch input device 1 according to the present invention comprises a touch sensing layer 11, a reattachable attachment member 12, a decorative layer 13, and a protective layer 14.

The touch sensing layer 11 is a flexible touch panel operable to generate a touch position signal in response to at least one touch action detected thereby and is one of a resistive sensing layer, a capacitive sensing layer, an inductive sensing layer, and a piezoelectric sensing layer. In this embodiment, the touch sensing layer 11 has a thickness ranging from 0.1 mm to 2 mm, but the invention is not limited in this respect.

The reattachable attachment member 12 is disposed under and fixed to the touch sensing layer 11 in this embodiment, and is made of one of natural rubber, synthetic rubber (silicone, CR, EPDM, SBRR, PU), resin (SBS, SEBS, EVA), adhesive, and electrostatic attraction material for releasable attachment of the reattachable touch input device 1 to a surface. In this embodiment, the reattachable attachment member 12 has a thickness ranging from 3 um to 200 um but the invention is not limited in this respect. It should be noted that the reattachable attachment member 12 may be separably attached to the touch sensing layer 11, and may have a thickness ranging from 10 um to 1 mm in other embodiments of this invention.

The protective layer 14 is a flexible film disposed above the touch sensing layer 11 and is made of one of a PET hard coat layer and a scratch-resistant coat layer for protecting the touch sensing layer 11.

The decorative layer 13 is a pattern formed between the protective layer 14 and the touch sensing layer 11 by a printing process and may be omitted in other embodiments of this invention. The total thickness of the protective layer 14 and the decorative layer 13 ranges from 5 um to 300 um.

Transparency of the reattachable attachment member 12, the touch sensing layer 11, and the protective layer 14 may vary according to application requirements. For example, the reattachable attachment member 12, the touch sensing layer 11, and the protective layer 14 may all be transparent, or one of the reattachable attachment member 12, the touch sensing layer 11, and the protective layer 14 may be opaque depending on the application of this invention.

For simplicity of illustration, in the following descriptions, an assembly of the touch sensing layer 11, the decorative layer 13, and the protective layer 14 are referred to as a touch sensing device 100.

As shown in FIG. 1, the reattachable touch input device 1 further comprises a processing module 10 that includes a controller 15, a microprocessor 16, a transmission module 17, and an electrical connector pair 19.

The controller 15 is coupled to the touch sensing layer 11 by the electrical connector pair 19 to receive the touch position signal therefrom, the touch position signal being generated in response to at least one touch action detected by the touch sensing layer 11. The controller 15 is configured to convert the touch position signal into a digital signal to be received by the microprocessor 16. The microprocessor 16 is coupled to the controller 15 to receive the digital signal therefrom and is configured to convert the digital signal into a positioning signal. It is noted that the electrical connector pair 19 is provided for removably and electrically connecting the controller 15 to the touch sensing layer 11 such that the processing module 10 of this invention may be used with other touch sensing devices 100 having different sizes.

The transmission module 17 is a wired transmission module coupled to the microprocessor 16 to receive and transmit the positioning signal for subsequent receipt by the electronic device (not shown). In this embodiment, the transmission module 17 is a USB transmission module. It can be appreciated that, as shown in FIG. 2, the transmission module 17 may be a wireless transmission module such as a Bluetooth transmission module, a WiFi transmission module, a Digital Living Network Alliance (DLNA) transmission module, a radio frequency transmission module, a microwave transmission module, or alight signal transmission module in other embodiments of this invention.

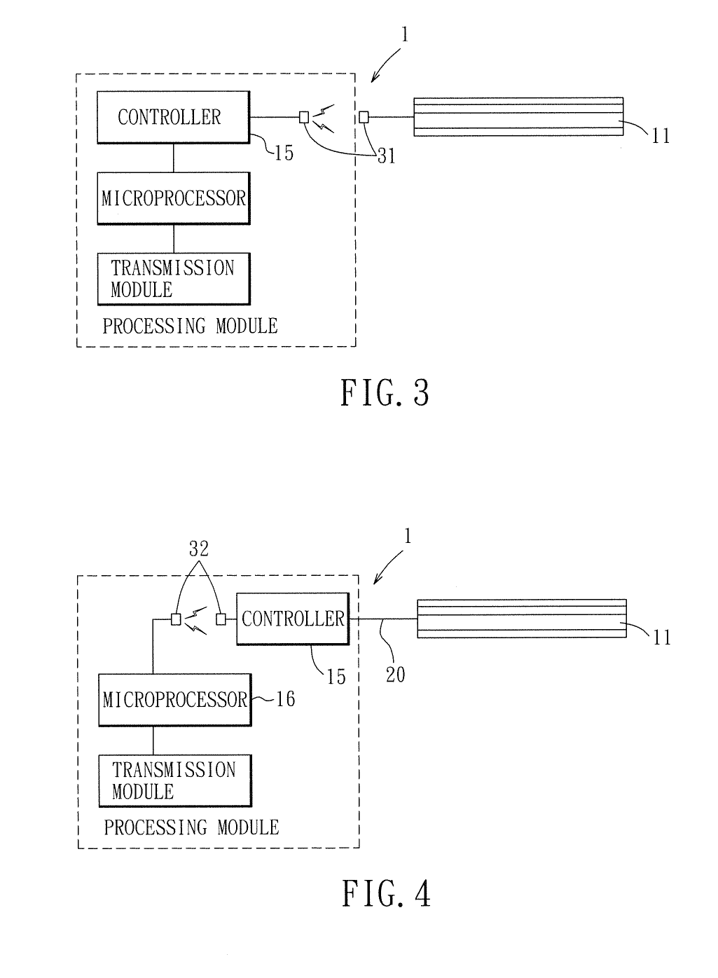

Referring to FIG. 3, another modification of the reattachable touch input device 1 is shown to include a wireless transmission device pair 31 for wirelessly transceiving the touch position signal from the touch sensing layer 11 to the controller 15. The electrical connector pair 19 shown in FIGS. 1 and 2 is thus omitted in this modification.

According to still another modification of this embodiment as illustrated in FIG. 4, the reattachable touch input device 1 further comprises a conductor 20 and another wireless transmission device pair 32. The conductor 20 is for electrically connecting the controller 15 to the touch sensing layer 11, and the wireless transmission device pair 32 is for wirelessly transceiving the digital signal from the controller 15 to the microprocessor 16.

Additionally, the reattachable touch input device 1 may comprise a power supply (not shown) such as a solar battery or a minicell battery module for providing electric power to the touch sensing device 100 and the processing module 10 when wireless transmission is employed in any one of the touch sensing device 100 and the processing module 10.

By virtue of the reattachable attachment member 12, the touch sensing device 100 can be releasably attached to a surface, such as a desk or a display screen of a notebook computer, to serve as a touch input interface for electronic devices.

In the following, three examples of using the reattachable touch input device 1 of the invention with different electronic devices are illustrated.

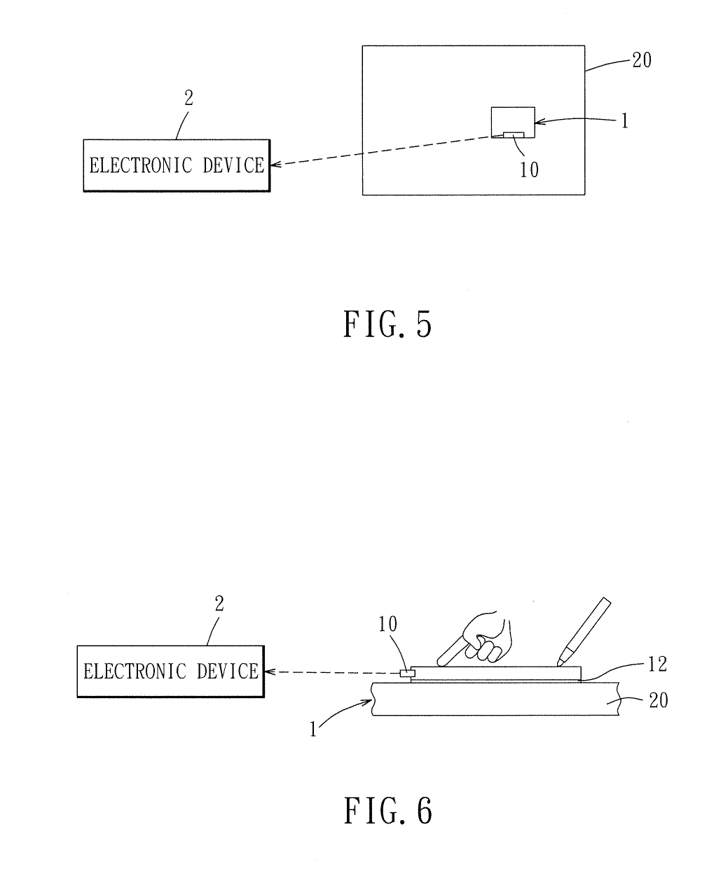

Referring to FIGS. 5 and 6, the reattachable touch input device 1 is attached to a display screen 20 of an electronic device 2 such as a notebook computer or a personal computer by the reattachable attachment member 12. A touch position signal is generated by the touch sensing layer 11 (see FIG. 1) in response to a touch action of an object or a finger detected thereby. The electronic device 2 receives a positioning signal generated by the processing module 10, and performs location identification to display location or movement track of the object or the finger on the display screen 20 or performs particular functions corresponding to the positioning signal. Therefore, the display screen 20 of the electronic device 2 may serve as a touch input screen.

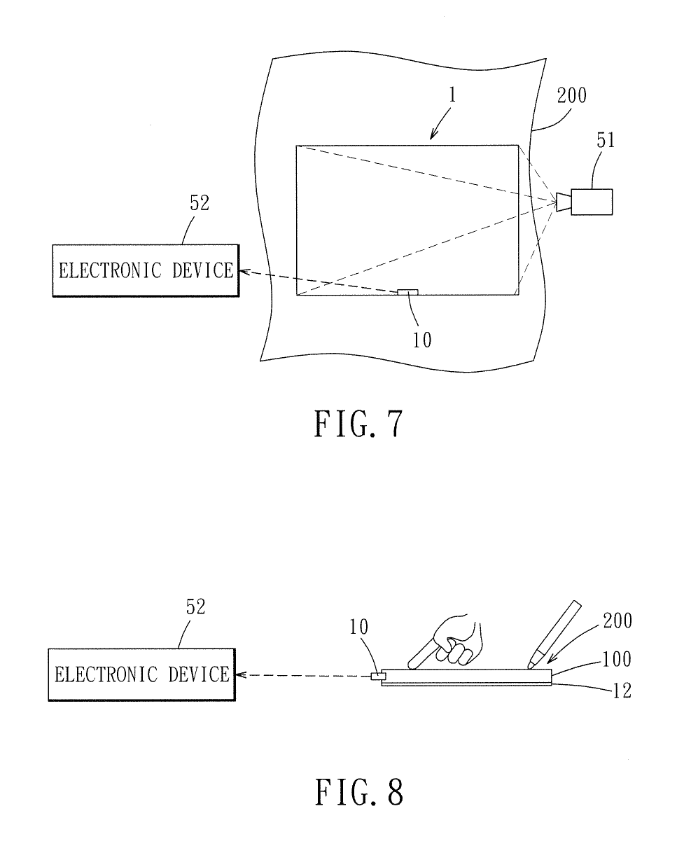

As shown in FIGS. 7 and 8, the reattachable touch input device 1 may be attached to a surface 200 on which a projected image from a projector 51 coupled to an electronic device 52 is displayed. A positioning signal generated by the processing module 10 is transmitted to the electronic device 52 when a touch action is detected by the touch sensing layer 11. The electronic device 52 performs location identification and transmits a corresponding signal to the projector 51 so as to display location or movement track of an object or fingers on the surface 200 to which the reattachable touch input device 1 is attached. It should be noted that the reattachable touch input device 1 may also serve as a remote controller when the electronic device is a digital television set-top-box.

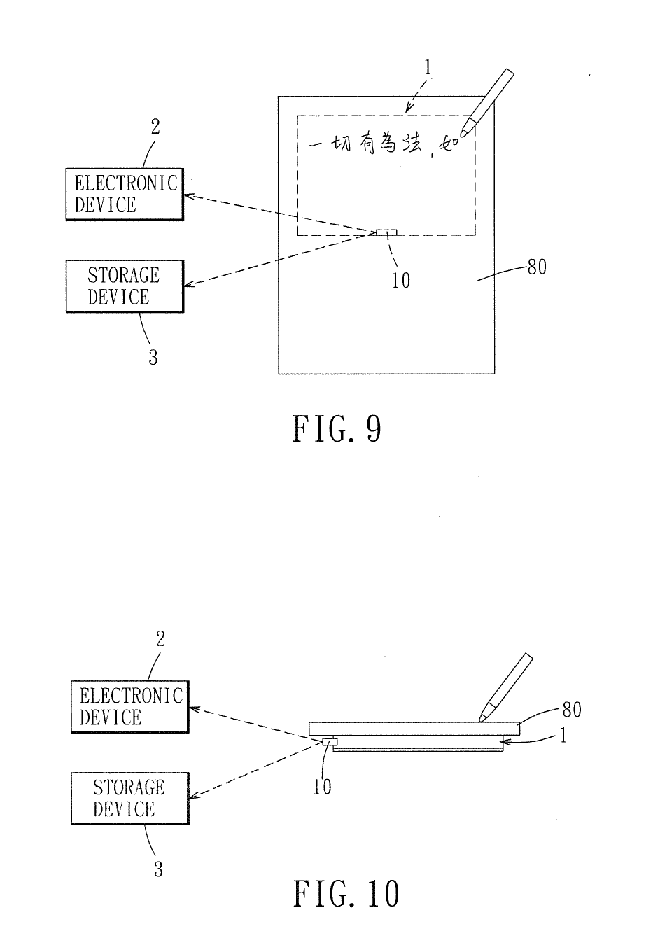

Referring to FIGS. 9 and 10, the reattachable touch input device 1 of the present invention may be disposed under a piece of paper 80. Handwriting of the user is thus digitized into a positioning signal that is generated by the processing module 10, and that is to be received by an electronic device 2, or that is to be stored in a storage device 3 such as a USB flash drive or an external hard disk for subsequent utilization by the electronic device 2.

To sum up, the advantages of the reattachable touch input device 1 of the present invention are as follows. The reattachable touch input device 1 may be used with various electronic devices without having to redesign the electronic devices and provides touch input functionality for the electronic devices. Additionally, the electrical connector pair 19 and the wireless transmission device pair 31 are respectively provided for wired and wireless transceiving of the touch position signal from the touch sensing layer 11 to the controller 15, such that the processing module 10 of this invention may be used with different sizes of touch sensing devices 100.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A reattachable touch input device for use with an electronic device, said reattachable touch input device comprising:
a touch sensing layer operable to generate a touch position signal in response to at least one touch action detected thereby; and
a reattachable attachment member disposed under said touch sensing layer and configured for releasable attachment of said reattachable touch input device to a surface.

2. The reattachable touch input device as claimed in claim 1, wherein said touch sensing layer is one of a resistive sensing layer, a capacitive sensing layer, an inductive sensing layer, and a piezoelectric sensing layer.

3. The reattachable touch input device as claimed in claim 1, wherein said reattachable attachment member is fixed to said touch sensing layer and is made of one of natural rubber, synthetic rubber, resin, adhesive, and electrostatic attraction material.

4. The reattachable touch input device as claimed in claim 1, wherein said reattachable attachment member is separably attached to said touch sensing layer.

5. The reattachable touch input device as claimed in claim 1, further comprising a protective layer disposed above said touch sensing layer.

6. The reattachable touch input device as claimed in claim 5, wherein said protective layer is one of a PET hard coat layer and a scratch-resistant coat layer.

7. The reattachable touch input device as claimed in claim 5, further comprising a decorative layer formed between said protective layer and said touch sensing layer.

8. The reattachable touch input device as claimed in claim 5, wherein at least one of said reattachable attachment member, said touch sensing layer, and said protective layer is opaque.

9. The reattachable touch input device as claimed in claim 5, wherein said reattachable attachment member, said touch sensing layer, and said protective layer are transparent.

10. The reattachable touch input device as claimed in claim 1, further comprising:
a controller coupled to said touch sensing layer to receive the touch position signal therefrom, and configured to convert the touch position signal into a digital signal;
a microprocessor coupled to said controller to receive the digital signal therefrom and configured to convert the digital signal into a positioning signal; and
a transmission module coupled to said microprocessor to receive and transmit the positioning signal for subsequent receipt by the electronic device.

11. The reattachable touch input device as claimed in claim 10, wherein said transmission module is a wired transmission module.

12. The reattachable touch input device as claimed in claim 11, wherein said wired transmission module is a USB transmission module.

13. The reattachable touch input device as claimed in claim 10, further comprising an electrical connector pair for removably and electrically connecting said controller to said touch sensing layer.

14. The reattachable touch input device as claimed in claim 10, further comprising:
a conductor for electrically connecting said controller to said touch sensing layer; and
a wireless transmission device pair for wirelessly transceiving the digital signal from said controller to said microprocessor.

15. The reattachable touch input device as claimed in claim 10, further comprising:
a wireless transmission device pair for wirelessly transceiving the touch position signal from said touch sensing layer to said controller.

16. The reattachable touch input device as claimed in claim 10, wherein said transmission module is a wireless transmission module.

17. The reattachable touch input device as claimed in claim 16, wherein said transmission module is one of a radio frequency transmission module, microwave transmission module and a light signal transmission module.
